(19) United States
(12) Patent Application Publication
(10) Pub. No.: US 2026/0246385 A1
(43) Pub. Date: Aug. 20, 2026

(54) RESONANT POWER CONVERTER

(71) Applicant: Infineon Technologies Austria AG, Villach (AT)

(72) Inventors: Osama ABDEL-RAHMAN, Coin Loop, FL (US); Alfredo Medina-Garcia, Muenchen (DE); Pierrick AUSSERESSE, München (DE)

(21) Appl. No.: 19/536,423

(22) Filed: Feb. 11, 2026

(30) Foreign Application Priority Data
Feb. 14, 2025 (DE) 102025105588.2

(51) Int. Cl. H02M 3/158; H02M 1/00; H02M 1/08; H02M 3/335

(52) U.S. Cl. CPC H02M 3/158; H02M 1/0058; H02M 1/08; H02M 3/1582; H02M 3/33584

(57) ABSTRACT

A power converter is presented. The power converter may comprise a transformer, a first bridge circuit, a second bridge circuit, and a bidirectional switching element. The first bridge circuit may comprise a first switch coupled between a first input of the power converter and an intermediate node. The first bridge circuit may comprise a second switch coupled between the intermediate node and a second input of the power converter. The bidirectional switching element may be coupled between a first terminal of a winding of the transformer and a second terminal of the winding of the transformer. The bidirectional switching element may be configured to short-circuit the winding of the transformer.

### RELATED APPLICATION

This application claims priority to earlier filed German Patent Application Serial Number 10 2025 105 588.2 entitled “RESONANT POWER CONVERTER,” (Attorney Docket No. 2024P07516DE), filed on Feb. 14, 2025, the entire teachings of which are incorporated herein by this reference.

### TECHNICAL FIELD

The present document relates to resonant power converters such as e.g. solar micro inverters. In particular, the present document relates to a topology and control method for implementing a three-level modulation for resonant power converters.

### BACKGROUND

Resonant power converters have the benefit of efficient high frequency operation due to zero voltage switching (ZVS). This may result in higher power density and smaller size. The cycloconverter-type microinverter is one case of resonant converter with a single stage and fewer power switches. Its modulation scheme allows a large soft-switching range and bidirectional power transmission ability. However, the principle of the cycloconverter is complex, with many degrees of freedom and currently lacks clear control strategies. More than one control input is necessary to modulate the average and instantaneous power delivery in a single conversion stage. Previous control methods for the cycloconverter include modulating three control parameters: An inner phase shift between two half bridge legs on the primary side, an outer phase shift between the primary full-bridge and secondary bridge, and the switching frequency.

### SUMMARY

According to an aspect, a power converter is presented. The power converter may comprise a transformer, a first bridge circuit, a second bridge circuit, and a bidirectional switching element. The first bridge circuit may comprise a first switch coupled between a first input of the power converter and an intermediate node and a second switch coupled between the intermediate node and a second input of the power converter. The bidirectional switching element may be coupled between a first terminal of a winding of the transformer and a second terminal of the winding of the transformer.

The power converter may be e.g. a resonant power converter. In particular, the power converter may be a direct current-alternating current (DC-AC) power converter, also denoted as DC-AC inverter. More specifically, the power converter may be a solar micro inverter configured to convert DC current generated by solar panels into AC current. The power converter or parts of it may also be denoted as cycloconverter. The power converter may be configured to generate a phase shift between the first bridge circuit and the second bridge circuit and, thus, the power converter may be also denoted as dual active bridge (DAB) converter.

The power converter may be e.g. a bidirectional power converter configured to allow power flow from the inputs (i.e. the first input and the second input) of the power converter to an output of the power converter and vice versa. Thus, when used with reversed power flow, the designation of input and output becomes misleading. Nevertheless, a power converter shall fall under the scope of the claims if the power converter is configured to allow power flow from the inputs to the output in at least one application scenario.

On the one hand, the first and second switch may be implemented with any suitable transistors, such as, for example, metal-oxide-semiconductor field effect transistors MOSFETs, insulated-gate bipolar transistors IGBTs, MOS-gated thyristors, or any other suitable power devices. For instance, the switches may be implemented using a III-V compound semiconductor material and may be e.g. GaN—high-electron-mobility transistors HEMTs. Each switch may have a control terminal (e.g. a gate) to which a respective control signal (e.g. driving voltage/current) may be applied to turn the switch on (i.e. to close the switch) or to turn the switch off (i.e. to open the switch). The first and second switch may be unidirectional switches. Unidirectional switches may be configured to conduct currents in both directions when turned on. When turned off, unidirectional switches may be configured to behave like a body diode which blocks current in one direction and conducts current (with a voltage drop) in the opposite direction.

On the other hand, the bidirectional switching element may not show said body diode behavior. When turned on, the bidirectional switching element may establish a low-ohmic channel and may be configured to conduct currents in both directions just as a unidirectional switch. When turned off, however, the bidirectional switching element may be configured to block currents in both directions. The bidirectional switching element, the first switch and the second switch may be controlled independent of each other using different control signals. The bidirectional switching element may me neither be directly connected to one of the inputs of the power converter, nor be directly connected to one of the outputs of the power converter.

The bidirectional switching element may be connected to the first terminal and the second terminal, and wherein the bidirectional switching element may be configured to short-circuit the winding of the transformer. Put in a different way, the bidirectional switching element may be configured to create a zero-voltage state between the first terminal and the second terminal of the transformer. Consequently, a zero-voltage state may be created at the output of the first bridge circuit. The bidirectional switching element may be configured to create, when turned on, the zero-voltage state between the first terminal and the second terminal of the transformer. To be specific, the bidirectional switching element may be configured to, when turned on, create the zero-voltage state between pulses of the first bridge circuit. Said pulses may be bipolar pulses, and the bidirectional switching element may be configured to, when turned on, create the zero-voltage state between two pulses of different polarity. In case the bidirectional switching element is implemented using two unidirectional switches, both unidirectional switches may be turned on to create said zero-voltage state. None of the switches of the first or second bridge circuit may be configured to short-circuit the winding of the transformer.

The power converter may be configured to control generation of pulses at the first bridge circuit using pulse width modulation PWM. Pulse width modulation PWM may also be denoted as duty cycle control. The first bridge circuit may comprise a left leg and a right leg. The power converter may be configured to keep a phase shift between the left leg and the right leg constant. In other words, the power converter may be configured to not modulate a phase shift between the left leg and the right leg of the first bridge circuit.

The power converter may be configured to control the first switch with a first duty cycle, and to control the second switch with a second duty cycle, wherein the first duty cycle and the second duty cycle are complementary. Hence, the second duty cycle may be determined as 1 minus the first duty cycle. The power converter may be configured to determine the first duty cycle e.g. based on a ratio of the input and output voltage, and derive the second duty cycle accordingly. Moreover, the switching of the first switch and the second switch may be synchronized in a sense that whenever the first switch is turned on the second switch is turned off, and vice versa.

The first bridge circuit may further comprise a third switch coupled between the first input of the power converter and a second intermediate node, and a fourth switch coupled between the second intermediate node and the second input of the power converter. The power converter may be configured to control the first and the fourth switch with the same control signal. Hence, the switching behavior of the first and the fourth switch may be synchronized and their on-times may be determined using duty cycle control. Likewise, the power converter may be configured to control the second and the third switch with the same control signal. Hence, the switching behavior of the second and the third switch may be synchronized and their on-times may be determined using duty cycle control.

The power converter may be configured to not turn on the first and the third switch at the same time. Thus, the on-times of the first and the third switch never overlap in time. Likewise, the power converter may be configured to not turn on the second and the fourth switch at the same time.

The power converter may be configured to control the on-times of the first, second, third, and fourth switch to be equal. The power converter may be configured to modulate the (common) on-time of said switches during operation of the power converter. For example, the power converter may be configured to modulate said on-time based on an input voltage of the power converter and/or based on a desired output voltage of the power converter.

Alternatively, the first bridge circuit may further comprise a first capacitor coupled between the first input of the power converter and a second intermediate node, and a second capacitor coupled between the second intermediate node and the second input of the power converter. By coupling the bidirectional switching element between the first and the second terminal of the transformer, it becomes possible reduce the number of switches used in the first bridge circuit from 4 to 2. As a result, the first and second capacitor may be used instead of another pair of switches which is typically used in the prior art for implementing phase shift control. In phase shift control based topologies, the zero-voltage state is created by simultaneously turning on two high-side transistors (like the above-described first and third switches) or two low-side transistors (like the above-described second and fourth switches). However, as the bidirectional switching element may create the zero-voltage state, the second high-side transistor and the second low-side transistor become dispensable and may be replaced by capacitors, thereby saving space and costs. As a further advantage, the bidirectional switching element takes over a portion of the current flowing through the first bridge circuit. In this way, the root mean square RMS current and losses in the high-side and low-side transistors are reduced, thereby reducing their temperatures.

The bidirectional switching element may comprise a monolithic gallium nitride GaN switch. The bidirectional switching element may be e.g. a dual-gate monolithic GaN switch with a common drift region. In other words, the bidirectional switching element may be a native four quadrant bidirectional switch.

The bidirectional switching element may comprise two unidirectional switches connected in an anti-serial connection. The anti-serial connection may also be denoted as back-to-back configuration. In other words, the two unidirectional switches may be arranged in a serial connection wherein the body diodes of both unidirectional switches are facing in opposite directions. Thus, the anti-serial connection may be implemented (a) by connecting the sources of the unidirectional switches or (b) by connecting the drains of the unidirectional switches. The unidirectional switches may be discrete transistors.

The bidirectional switching element may be configured to, when turned on, allow current flow in a first direction from the first terminal to the second terminal or in a second direction from the second terminal to the first terminal. The bidirectional switching element may be configured to, when turned off, block current flow in a first direction from the first terminal to the second terminal and in a second direction from the second terminal to the first terminal.

The transformer may comprise a primary winding coupled to the first bridge circuit and a secondary winding coupled to the second bridge circuit. The primary winding may be electrically isolated from the secondary winding. In addition, the transformer may comprise one or more portions of magnetic material. The winding may be also denoted as coil. The winding may comprise one or more full turns. The winding may be made of some conductive material such as e.g. copper. The winding may be seen as an inductive element capable of storing magnetic energy in a magnetic field.

The winding of the transformer may be a primary winding, and the first bridge circuit may be coupled between an input of the power converter and the primary winding of the transformer. In other words, the bidirectional switching element may be located at the primary side of the power converter. In this scenario, the intermediate node between the first switch and the second switch may be the first or the second terminal of the primary winding of the transformer. Likewise, the second intermediate node may be the first or the second terminal of the primary winding of the transformer.

The power converter may further comprise a resonant capacitor coupled between the first terminal of the primary winding of the transformer and the bidirectional switching element. More specifically, the resonant capacitor may comprise a first terminal and a second terminal. The first terminal of the resonant capacitor may be coupled to the first terminal of the primary winding of the transformer. The bidirectional switching element may be coupled in between the second terminal of the resonant capacitor and the second terminal of the primary winding of the transformer.

The power converter comprising said resonant capacitor may then be operated as resonant inductor-inductor-capacitor LLC power converter e.g. by using duty cycle modulation. A switching frequency of the first bridge circuit may be chosen such that resonance between the resonant capacitor and an inductive element of the transformer occurs.

The winding of the transformer may be a secondary winding, and the second bridge circuit may be coupled between the secondary winding of the transformer and an output of the power converter. In other words, the bidirectional switching element may be located at the secondary side of the power converter.

The second bridge circuit may comprise a first switching element coupled in between a first output terminal of the transformer and a first output of the power converter and a second switching element coupled in between the first output terminal of the transformer and a second output of the power converter. For example, the first and the second switching element may be implemented as bidirectional switches. Alternatively, the first and the second switching element may be implemented using two back-to-back unidirectional switches, respectively.

The second bridge circuit may be implemented as half-bridge. The second bridge circuit may further comprise a first output capacitor coupled in between a second output terminal of the transformer and the first output of the power converter, and a second output capacitor coupled in between the second output terminal of the transformer and the second output of the power converter.

The second bridge circuit may be implemented as full-bridge. The second bridge circuit may further comprise a third switching element coupled in between a second output terminal of the transformer and the first output of the power converter, and a fourth switching element coupled in between the second output terminal of the transformer and the second output of the power converter. Again, the third and the fourth switching element may be implemented as bidirectional switches. Alternatively, the third and the fourth switching element may be implemented using two back-to-back unidirectional switches, respectively.

According to another aspect, a method of operating a power converter is presented. The method may comprise steps corresponding to the functional features of the power converter described throughout this document. The power converter may comprise a transformer, a first bridge circuit, a second bridge circuit, and a bidirectional switching element. The first bridge circuit may comprise a first switch coupled between a first input of the power converter and an intermediate node and a second switch coupled between the intermediate node and a second input of the power converter. The bidirectional switching element may be coupled between a first terminal of a winding of the transformer and a second terminal of the winding of the transformer. The method may comprise creating a zero-voltage state between the first terminal and the second terminal of the transformer by turning on the bidirectional switching element.

The method may comprise controlling generation of pulses at the first bridge circuit using pulse width modulation PWM.

The method may comprise controlling the first switch with a first duty cycle (or first pulse width), and to control the second switch with a second duty cycle (or pulse width), wherein the first duty cycle and the second duty cycle are complementary. The method may comprise turning the first switch on when the second switch is turned off, and vice versa. Of course, dead-times may be included where needed.

The first bridge circuit may comprise a left leg and a right leg, and the method may comprise keeping a phase shift between the left leg and the right leg constant. The left leg may comprise the first switch and the second switch. Alternatively, the right leg may comprise the first switch and the second switch.

The first bridge circuit may further comprise a third switch coupled between the first input of the power converter and a second intermediate node, and a fourth switch coupled between the second intermediate node and the second input of the power converter. The method may comprise controlling the first and the fourth switch with the same control signal. The method may comprise not turning on the first and the third switch at the same time. The method may comprise controlling the on-times of the first, second, third, and fourth switch to be equal.

Alternatively, the first bridge circuit may further comprise a first capacitor coupled between the first input of the power converter and a second intermediate node, and a second capacitor coupled between the second intermediate node and the second input of the power converter. The bidirectional switching element may comprise a monolithic gallium nitride GaN switch. The bidirectional switching element may comprise two unidirectional switches in a back-to-back configuration.

The method may comprise turning on the bidirectional switching element to allow current flow in a first direction from the first terminal to the second terminal or in a second direction from the second terminal to the first terminal. The method may comprise turning off the bidirectional switching element to block current flow in a first direction from the first terminal to the second terminal and in a second direction from the second terminal to the first terminal.

The winding of the transformer may be a primary winding, and the first bridge circuit may be coupled between an input of the power converter and the primary winding of the transformer. The method may comprise coupling a resonant capacitor between the first terminal of the primary winding of the transformer and the bidirectional switching element. Alternatively, the winding of the transformer may be a secondary winding, and the second bridge circuit may be coupled between the secondary winding of the transformer and an output of the power converter.

The method may comprise coupling, in the second bridge circuit, a first switching element in between a first output terminal of the transformer and a first output of the power converter, and coupling a second switching element in between the first output terminal of the transformer and a second output of the power converter.

The method may comprise coupling a first output capacitor in between a second output terminal of the transformer and the first output of the power converter, and coupling a second output capacitor in between the second output terminal of the transformer and the second output of the power converter. As an alternative, the method may comprise, in the second bridge circuit, a third switching element in between the second output terminal of the transformer and the first output of the power converter, and coupling a fourth switching element in between the second output terminal of the transformer and the second output of the power converter.

It should be noted that the methods and systems including its preferred embodiments as outlined in the present document may be used stand-alone or in combination with the other methods and systems disclosed in this document. In addition, the features outlined in the context of a system are also applicable to a corresponding method. Furthermore, all aspects of the methods and systems outlined in the present document may be arbitrarily combined. In particular, the features of the claims may be combined with one another in an arbitrary manner.

In the present document, the term “couple” or “coupled” refers to elements being in electrical communication with each other, whether directly connected e.g., via wires, or indirectly connected via other circuit elements between them. For example, two elements may be said to be coupled even if there is a circuit element such as a switch (which may be turned on and off) in between them. On the other hand, the term “connect” or “connected” refers to elements being directly electrically connected with each other, e.g. via wires, and no circuit elements are located between them.

### BRIEF DESCRIPTION OF THE FIGURES

The present invention is illustrated by way of example, and not by way of limitation, in the figures in which like reference numerals refer to similar or identical elements, and in which

FIG. 1 shows an exemplary power converter topology,

FIG. 2 shows an exemplary modulation scheme for the topology in FIG. 1,

FIG. 3 shows exemplary signal waveforms for the topology in FIG. 1,

FIG. 4 shows another exemplary modulation scheme for the topology in FIG. 1,

FIG. 5 shows another exemplary power converter topology,

FIG. 6 shows an exemplary modulation scheme for the topology in FIG. 5,

FIG. 7 shows yet another exemplary power converter topology,

FIG. 8 shows an exemplary LLC topology,

FIG. 9 shows a modulation scheme and other signal waveforms of the LLC topology in FIG. 8,

FIG. 10 shows an exemplary power converter topology with the bidirectional switching element coupled to the secondary winding of the transformer.

### DETAILED DESCRIPTION

As already described in the foregoing sections, a bidirectional switching element is applied that allows 3-level modulation of the primary bridge of a resonant power converter. At this, the bridge voltage pulse width may be controlled with duty cycle modulation control, rather than phase shift modulation.

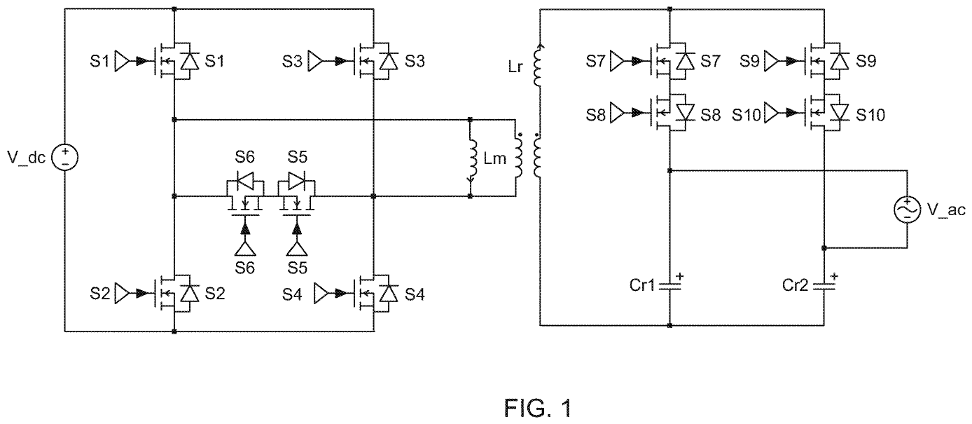

FIG. 1 shows an exemplary power converter topology. Specifically, FIG. 1 displays an example cycloconverter with a novel primary/first bridge circuit, other derivative resonant topologies can also be implemented with this novel primary bridge circuit. In this example, the first bridge circuit comprises a first switch S1, a second switch S2, a third switch S3, and a fourth switch S4. Further, the novel primary bridge comprises an additional bidirectional switching element connected across the full bridge output, which can create the zero-voltage state between the positive and negative levels, which allows the primary bridge output to be controlled using pulse width modulation or duty cycle (D) as control input (rather than phase-shift modulation of previous solutions). In this example, the bidirectional switching element is implemented using 2 back-to-back unidirectional switches S5 and S6 (both sources are connected). Alternatively, switches S5 and S6 may also be drain-connected (not shown). In addition, the outer phase shift between the two bridge circuits and the switching frequency Fs are the two other control inputs which may be used to modulate the converter voltage gain and power delivery, similar to the aforementioned control methods for cyclo converters.

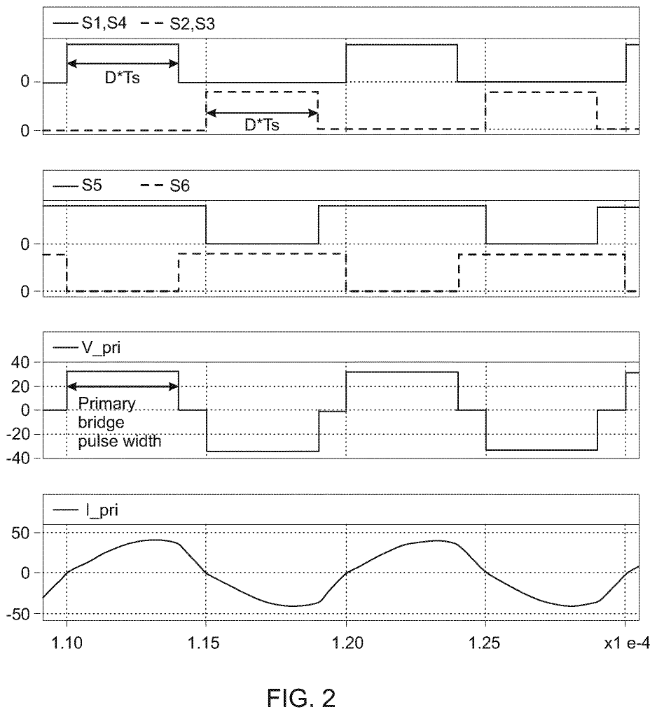

FIG. 2 shows an exemplary modulation scheme for the topology in FIG. 1. In the top two diagrams, the control signals (or drive signals) for the switches are displayed. A low signal level (0) means the switch is turned off, and a high signal level means the switch is turned on. D denotes the duty cycle, and Ts the cycle duration (i.e. the inverse of the switching frequency Fs). The bottom two diagrams illustrate the voltage V_pri across and the current I_pri through the primary winding of the transformer.

As can be seen in the top two diagrams, switches pairs S1,S4 and S2,S3 may be controlled with the same duty cycle, and may be 180 degrees shifted. S6 may be the complementary pulse of S1,S4, and S5 may be the complementary pulse of S2,S3. This modulation pattern creates a positive voltage state when S1,S4 are turned on and a negative voltage state when S2,S3 are turned on, which allows for power delivery. A zero-voltage state is created when S5,S6 are turned on, which allows for resonant current freewheeling.

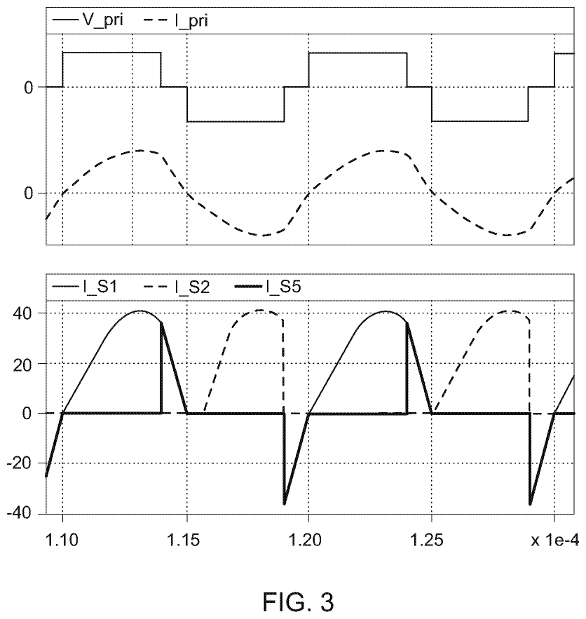

FIG. 3 shows exemplary currents through the switches on the primary side of the power converter. One possible advantage of this novel primary bridge 3-level modulation is that the freewheeling portion of the primary current is removed from the active switches S1-S4 and moved to the center leg switches S5,S6, as shown in FIG. 3, which reduces the RMS current and losses in S1-S4, therefore reducing their temperature.

The center leg switches S5,S6 may have the same voltage blocking rating as the the other primary switches (60-80V in the case of cyclo microinverter application). Since they only conduct the resonant freewheeling current, their RMS current and losses are lower, this allows the center leg switches S5,S6 to have a higher drain-source on resistance Rds. on and smaller packages.

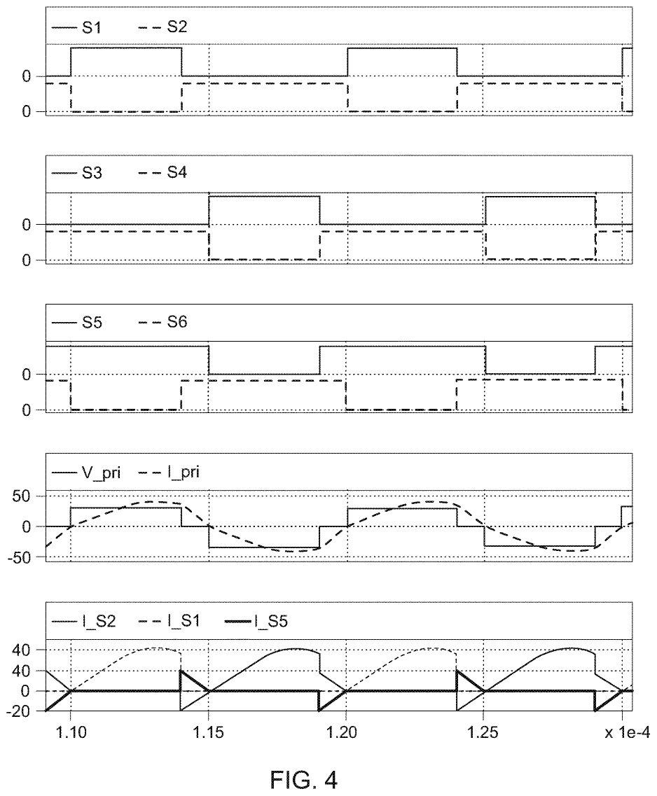

An alternative modulation scheme is shown in FIG. 4. Here, the bottom switches S2 and S4 may be driven with a complementary duty ratio compared to S1 and S3, respectively. The output of the bridge and operation of the converter remain the same, but we get a benefit of even lower RMS current in the center leg switches. This may become possible because the lower switches are turned on during the freewheeling period, and share the current with the center leg switches. Simulation showed 50% reduction in the center leg RMS current and 3% increase in the lower switch RMS current compared to the previous modulation scheme shown in FIG. 2. This may enable using even smaller packages and higher Rds,on for the center leg switches to reduce cost and printed circuit board (PCB) area, without compromising efficiency.

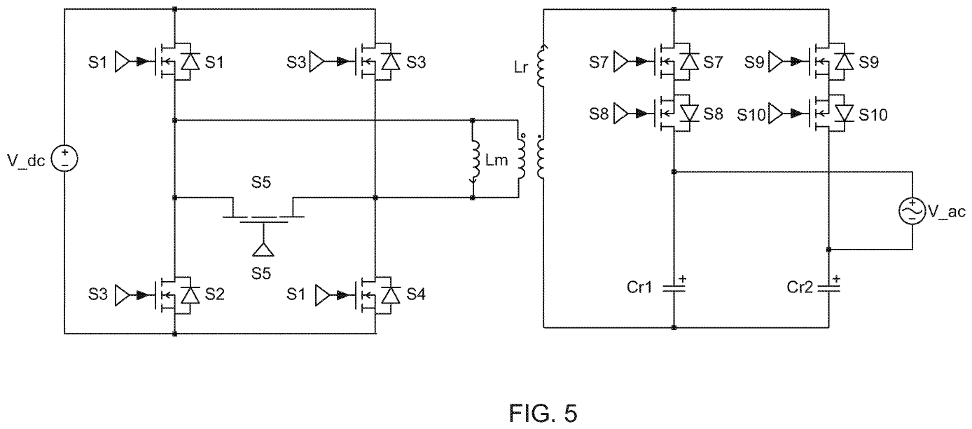

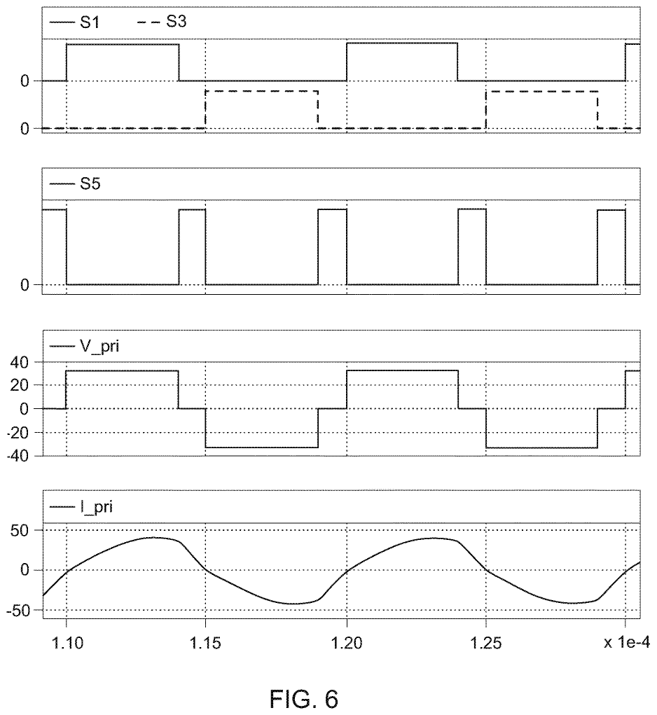

An alternative implementation includes the use of a Gallium Nitride (GaN) monolithic bidirectional switch (BDS) in the center leg, as seen in FIG. 5. The BDS switch S5 is illustrated to have a single gate. However, also implementations with a dual-gate BDS are possible. In general, usage of a monolithic BDS offers some efficiency benefits due to the reduced conduction loss during freewheeling period, since the current freewheels through one device Rds,on versus two devices, as in the case of two discrete switches in FIG. 1. The center leg may be controlled by a single control signal as shown in FIG. 6. This pulse is only high during the freewheeling period, and may be simply generated by a NOR logic operation of the S1 and S3 control signals. Please note that in FIG. 5, the control signal S1 is applied to switches S1 and S4, and that control signal S3 is applied to switches S3 and S2.

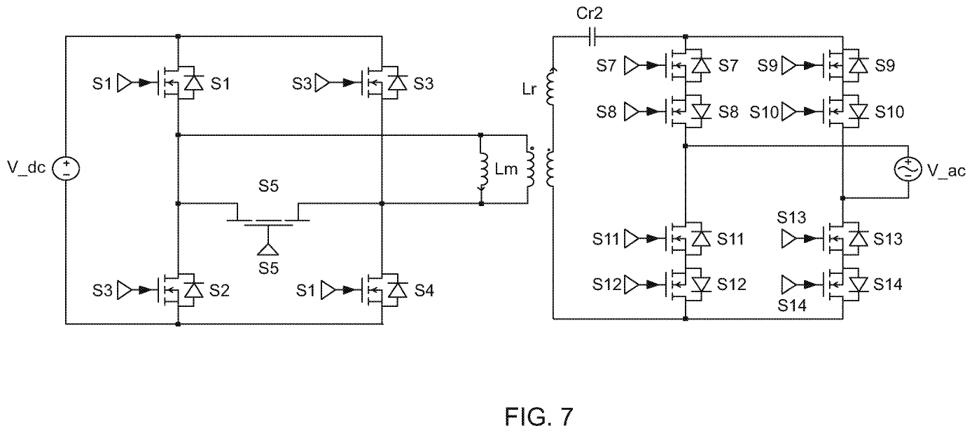

FIG. 7 shows yet another exemplary power converter topology. To be more specific, FIG. 7 shows an implementation where the secondary bridge is a full bridge, with 4 bidirectional switching elements, which may be implemented with eight discrete switches or four monolithic GaN BDS switches.

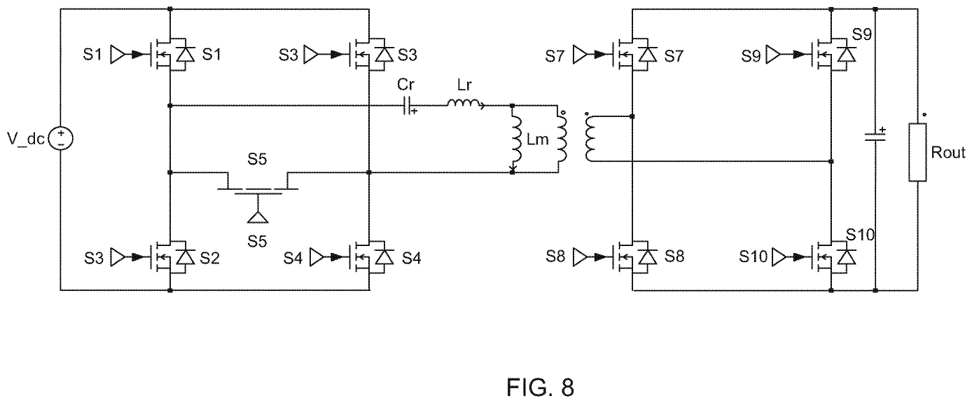

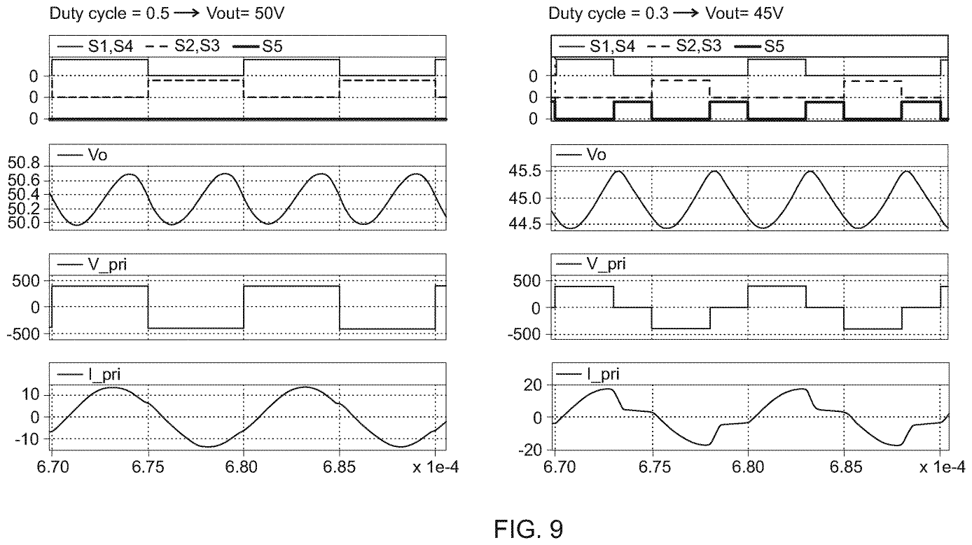

Another application of this invention can be for SMPS applications, specifically in a resonant inductor-inductor-capacitor LLC topology that is typically controlled using frequency modulation. The center leg may enable 3-level modulation of the resonant tank, which offers another control input and degree of freedom. FIG. 8 shows an LLC converter having a bidirectional switching element for coupled to a resonant capacitor Cr of the LLC circuit. FIG. 9 shows two simulation cases for duty cycle D=0.5 and D=0.3. It shows that voltage can be controlled using duty cycle modulation without changing switching frequency. In the application, this may enable the LLC to have a wider voltage gain range, without compromising the resonant tank design optimization and efficiency, where frequency can be modulated through a part of the gain range, beyond that range then frequency is limited to some value and duty cycle modulation may be used.

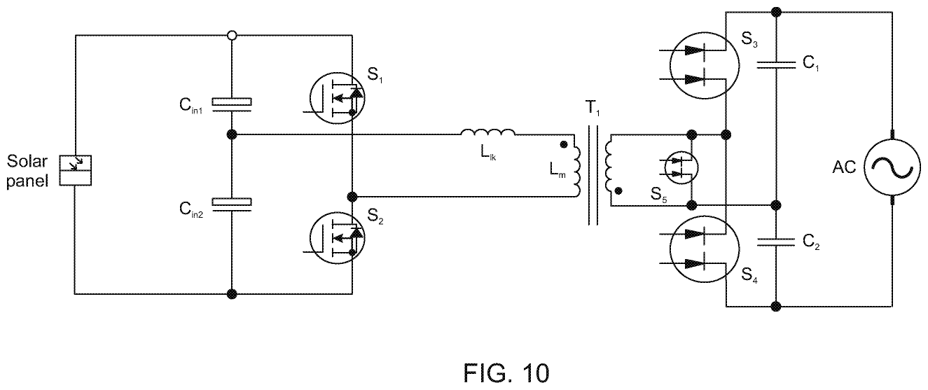

Finally, FIG. 10 shows an exemplary power converter topology with the bidirectional switching element S5 coupled to the secondary winding of the transformer. In the illustrated example, half-bridges are used for the primary and secondary side. Nevertheless, also full-bridges are possible. At this, the zero voltage state on the primary side of the transformer may be generated by turning the bidirectional switching element S5 and thereby short-circuiting the secondary winding of the transformer.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

1) A power converter comprising:
a transformer, a first bridge circuit, a second bridge circuit, and a bidirectional switching element;
wherein the first bridge circuit comprises: i) a first switch coupled between a first input of the power converter and an intermediate node, and ii) a second switch coupled between the intermediate node and a second input of the power converter; and
wherein the bidirectional switching element is coupled between a first terminal of a winding of the transformer and a second terminal of the winding of the transformer.

2) The power converter according to claim 1, wherein the bidirectional switching element is connected to the first terminal and the second terminal, and wherein the bidirectional switching element is configured to short-circuit the winding of the transformer.

3) The power converter according to claim 1, wherein the power converter is configured to control generation of pulses at the first bridge circuit using pulse width modulation PWM.

4) The power converter according to claim 1, wherein the power converter is configured to control the first switch with a first duty cycle, and to control the second switch with a second duty cycle, wherein the first duty cycle and the second duty cycle are complementary.

5) The power converter according to claim 1, wherein the first bridge circuit comprises a left leg and a right leg, and wherein the power converter is configured to maintain a fixed phase shift between the left leg and the right leg.

6) The power converter according to claim 1, wherein the first bridge circuit further comprises a third switch coupled between the first input of the power converter and a second intermediate node, and a fourth switch coupled between the second intermediate node and the second input of the power converter, and wherein the power converter is configured to control the first switch and the fourth switch with the same control signal.

7) The power converter according to claim 6, wherein the power converter is configured to prevent turn on of the first switch and the third switch at the same time.

8) The power converter according to claim 7, wherein the power converter is configured to control the on-times of the first switch, second switch, third switch, and fourth switch to be equal.

9) The power converter according to claim 1, wherein the first bridge circuit further comprises a first capacitor coupled between the first input of the power converter and a second intermediate node, and a second capacitor coupled between the second intermediate node and the second input of the power converter.

10) The power converter according to claim 1, wherein the bidirectional switching element comprises a monolithic gallium nitride GaN switch.

11) The power converter according to claim 1, wherein the bidirectional switching element comprises two unidirectional switches connected in an anti-serial connection.

12) The power converter according to claim 1, wherein the bidirectional switching element is configured to, when turned on, allow first current flow in a first direction from the first terminal to the second terminal for a first time duration and allow second current flow in a second direction from the second terminal to the first terminal for a second time duration.

13) The power converter according to claim 1, wherein the bidirectional switching element is configured to, when turned off, block current flow both in a first direction from the first terminal to the second terminal and in a second direction from the second terminal to the first terminal.

14) The power converter according to claim 1, wherein the winding of the transformer is a primary winding, and wherein the first bridge circuit is coupled between the first input and the second input of the power converter and the primary winding of the transformer.

15) The power converter according to claim 14, further comprising a resonant capacitor coupled between the first terminal of the primary winding of the transformer and the bidirectional switching element.

16) The power converter according to claim 1, wherein the winding of the transformer is a secondary winding, and wherein the second bridge circuit is coupled between the secondary winding of the transformer and an output of the power converter.

17) The power converter according to claim 1, wherein the second bridge circuit comprises a first switching element coupled in between a first output terminal of the transformer and a first output of the power converter and a second switching element coupled in between the first output terminal of the transformer and a second output of the power converter.

18) The power converter according to claim 17, wherein the second bridge circuit further comprises a first output capacitor coupled in between a second output terminal of the transformer and the first output of the power converter, and a second output capacitor coupled in between the second output terminal of the transformer and the second output of the power converter.

19) The power converter according to claim 17, wherein the second bridge circuit further comprises a third switching element coupled in between a second output terminal of the transformer and the first output of the power converter, and a fourth switching element coupled in between the second output terminal of the transformer and the second output of the power converter.

20) A method of operating the power converter of claim 1, the method comprising:
creating a zero-voltage state between the first terminal and the second terminal of the transformer by turning on the bidirectional switching element.
